(19) United States
(12) Patent Application Publication
(10) Pub. No.: US 2013/0086991 A1
(43) Pub. Date: Apr. 11, 2013

(54) DETECTION PROCESS

(71) Applicants: Francis Alexander REED, Duanesburg, NY (US); Robin Carl SCHWANT, Pattersonville, NY (US); Curtis Wayne ROSE, Mechanicville, NY (US); William Raymond BROWN, Schenectady, NY (US)

(72) Inventors: Francis Alexander REED, Duanesburg, NY (US); Robin Carl SCHWANT, Pattersonville, NY (US); Curtis Wayne ROSE, Mechanicville, NY (US); William Raymond BROWN, Schenectady, NY (US)

(73) Assignee: GENERAL ELECTRIC COMPANY, Schenectady, NY (US)

(21) Appl. No.: 13/268,058

(22) Filed: Oct. 7, 2011

(51) Int. Cl. G01N 19/08

(52) U.S. Cl. 73/799

(57) ABSTRACT

A detection process is disclosed. The detection process includes applying a load to a preselected portion of an article. The applying of the load permits visually indiscernible cracks in the preselected portion of the article to be detected. The treated article includes a preselected portion having treated visually indiscernible cracks. The treated visually indiscernible cracks are substantially devoid of damage due to the treatment of the visually indiscernible cracks.

### FIELD OF THE INVENTION

The present invention relates to non-destructive testing techniques and manufactured and repaired articles treated in conjunction with such non-destructive testing techniques. More specifically, the present invention relates to processes for detecting small cracks in metal or metallic articles and articles having such small cracks being treated.

### BACKGROUND OF THE INVENTION

Metal and/or metallic components are used in a wide variety of industrial applications, under a diverse set of operating conditions. Such operating conditions can include high temperatures, low temperatures, broad ranges of temperatures, high or low moisture environments, broad ranges of moisture environments, corrosive environments, vibrating or oscillating uses, or other potentially harsh environments and/or uses.

In many cases, the components are treated to withstand such operating conditions. As one example, various components of turbine engines are often coated with coatings to increase the temperature at which they can operate. Other examples of articles which require some sort of protective coating include pistons used in internal combustion engines and other types of machines. Although such coatings can extend an operational life of components, the components are still limited by internal structural characteristics such as cracks. Such cracks can be treated when detected.

Certain known processes have been used for detecting cracks. For example, a partially destructive technique, such as cleaning and etching of metal surfaces, can be used for treating cracks. Such techniques can even detect and treat small cracks that have not previously been detectable by non-destructive techniques such as visual analysis. Etching can include using an acid solution to open or expand cracks, the visually indiscernible cracks such that they can be detected. Etching can suffer from the drawbacks that opening or expanding the visually indiscernible cracks can damage the component, the etching can damage grain boundaries of the component and/or the etching can result in a reduction in compressive stress resistance of the component.

Other detection processes can include using non-destructive inspection technology, such as in eddy current testing, magnetic particle testing, penetrant testing, and/or visual testing. Eddy current testing is not widely available, can be difficult to apply to large regions, can take a long time to complete, and/or can be expensive to implement. Magnetic particle testing can be difficult to apply to large regions, can take a long time to complete, and/or can be expensive to implement. Penetrant testing is not able to reach cracks that are sealed by debris (such as dirt) during operation. Visual analysis has long been inconsistent and unreliable, especially with smaller cracks.

A process for detecting smaller cracks and a treated article having treated smaller cracks not suffering from one or more of the above drawbacks would be desirable in the art.

### BRIEF DESCRIPTION OF THE INVENTION

In an exemplary embodiment, a detection process includes applying a load to a preselected portion of an article during a non-operational mode. The applying of the load permits visually indiscernible cracks in the preselected portion of the article to be detected.

In another exemplary embodiment, a detection process includes applying a load to a preselected portion of an article and treating the visually indiscernible cracks. The applying of the load permits visually indiscernible cracks in the preselected portion of the article to be detected.

In another exemplary embodiment, a detection process includes applying a load to a preselected portion of an article to reveal visually indiscernible cracks and identifying the visually indiscernible cracks.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a side view of an article having visually indiscernible cracks being detected according to an exemplary embodiment of the disclosure.

FIG. 2 is a process flow diagram of a process for detecting visually indiscernible cracks according to an exemplary embodiment of the disclosure.

Wherever possible, the same reference numbers will be used throughout the drawings to represent the same parts.

### DETAILED DESCRIPTION OF THE INVENTION

Provided is a process for detecting visually indiscernible cracks and a treated article having treated visually indiscernible cracks. Embodiments of the present disclosure permit detection of visually indiscernible cracks, permit treatment of visually indiscernible cracks, permit increased usable life for components, permit increased safety, permit decreased costs associated with inspection and/or repair, permit use of components under greater tension loads, permit increased capability for receiving treatments such as shot peening (for example, by reducing or eliminating risk of having cracks which penetrate through compressive stress regions proximal to surfaces of a component), permit increased reliability on inspections, and combinations thereof.

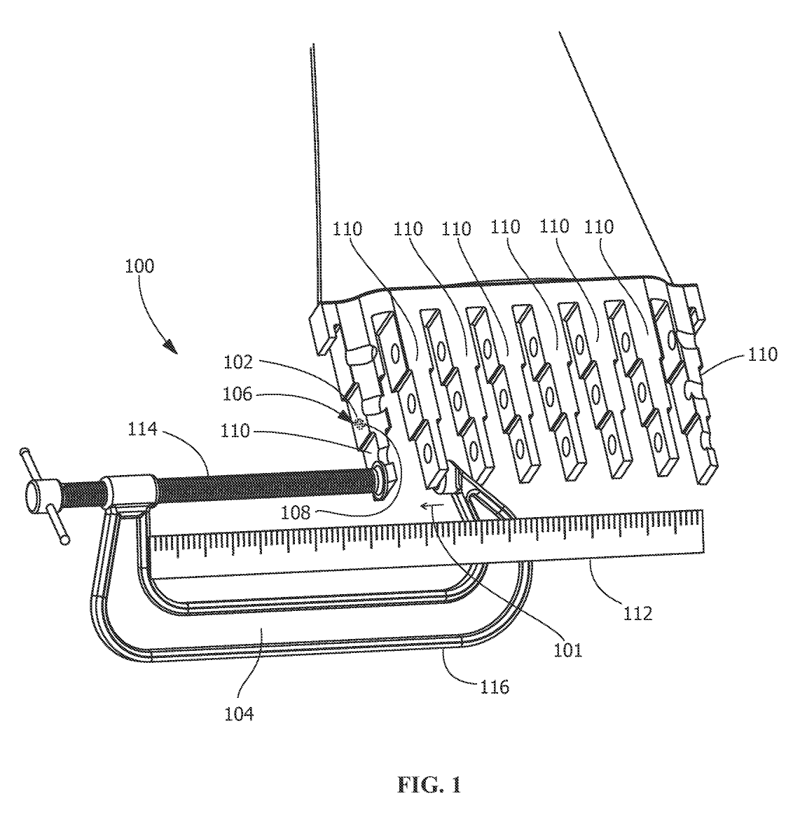

Referring to FIG. 1, an article 100 having visually indiscernible cracks 102 is shown. As used herein, the term “visually indiscernible crack,” refers to a crack that is not identifiable through unaided visual inspection absent providing a load according to the disclosure. The visually indiscernible cracks 102 shown in FIG. 1 are shown merely for reference and may or may not be positioned in different portions of the article 100, may or may not have different relative sizes, may or may not have different relative density, may or may not have different shapes, or may or may not have other differences that would be understood by those skilled in the art. Characteristics of the visually indiscernible cracks 102, such as, the size of the visually indiscernible cracks 102, the amount of the visually indiscernible cracks 102, the shape of the visually indiscernible cracks 102, the depth of the visually indiscernible cracks 102, other characteristics of the visually indiscernible cracks 102, and combinations thereof, are based upon features of the article 100, such as the composition of the article 100, the process of forming the article 100, the geometry of the article 100, the forces applied to the article 100 during operation (for example, when the process herein described is used as a repair technique), other characteristics of the article 100, and combinations thereof. In one embodiment, the visually indiscernible cracks 102 are between about 0.015 inches deep and about 0.1 inches deep, between about 0.05 inches and about 0.1 inches deep, between about 0.015 inches and about 0.05 inches deep, or combinations and sub-combinations thereof.

The load is applied to the article 100 by a load-providing device 104 along a load direction. Upon applying the load in the load direction 101 (for example, in a direction correlated to a preselected portion 106 and/or a surface 108 of the article 100), detection of the visually indiscernible cracks 102 is achievable, for example, due to opening or expanding of the visually indiscernible cracks 102. In one embodiment the force applied as the load is a predetermined force resulting in detectability of the visually indiscernible cracks 102.

The load is applied during a non-operational mode of the article 100 or during an operational mode of the article 100. The applying of the load results in increased detectability of the visually indiscernible cracks 102 in the preselected portion 106 of the article 100. In one embodiment, the preselected portion 106 is a region where operation of the article 100 results in the greatest amount of compressive stress. In one embodiment, the visually indiscernible cracks 102 are on the surface 108 or other preselected region of the article 100. In one embodiment, the preselected portion 106 is the portion proximal to a threaded portion 114 of the load providing device 104 and/or in a region with a force being applied to it. In one embodiment, the preselected portion 106 is a portion with centripetal forces applied, for example, as in airfoils (buckets and/or blades), turbine wheels and shafts, and/or attachments to rotors, such as, dovetail attachments and lower airfoil regions.

The article 100 is any suitable product or component capable of having the load applied to increase detectability of the visually indiscernible cracks 102. In one embodiment, the article 100 is a rotating component, an attachment component, and/or a centripetally loaded component for a turbine, such as a gas turbine, a steam turbine, a wind turbine, or any other turbine. In further embodiments, the article 100 is a bucket, a nozzle, a blade, a rotor, a vane, a stator, a shroud, a blisk, a wheel, or a shaft. In another embodiment, the article 100 is a component for a non-turbine system, such as an internal combustion engine, or other system having oscillating components. In further embodiments, the article 100 is a piston, a compressor housing, injectors, piston rings, cylinders, or regulators. As shown in FIG. 1, in one embodiment, the article 100 includes a plurality of bucket fingers 110 and/or is part of a last stage bucket for a steam turbine, such as a steam turbine having 40-inch last stage buckets.

The article 100 includes a metal or metallic material. For example, in one embodiment, the article 100 is a titanium-based alloy. In other embodiments, the article is a nickel-based alloy, a cobalt-based alloy, stainless steel, any other suitable alloy, or combinations thereof.

The load-providing device 104 is an external device capable of generating the load. Exemplary load-providing devices 104 include, but are not limited to, clamps (such as the C-clamp shown in FIG. 1), vices, suspended weights, wedges capable of being inserted within the article 100 and/or between the article 100 and another surface, levers, or any other suitable tool capable of providing a substantially consistent amount of force as the load in the load direction 101, such as in a direction to bend the preselected portion 106 and/or the surface 108, in a direction to open or expand the visually indiscernible cracks 102 in the preselected portion 106 and/or the surface 108, in a direction that reveals visually indiscernible cracks 102 within the preselected portion 106 and/or the surface 108, in a direction resulting in deflection of the preselected portion 106 and/or the surface 108, in a direction corresponding to the orientation of the preselected portion 106 and/or the surface 108, or combinations thereof. In further embodiments, the direction is perpendicular, at an oblique, or parallel to the preselected portion 106 and/or the surface 108.

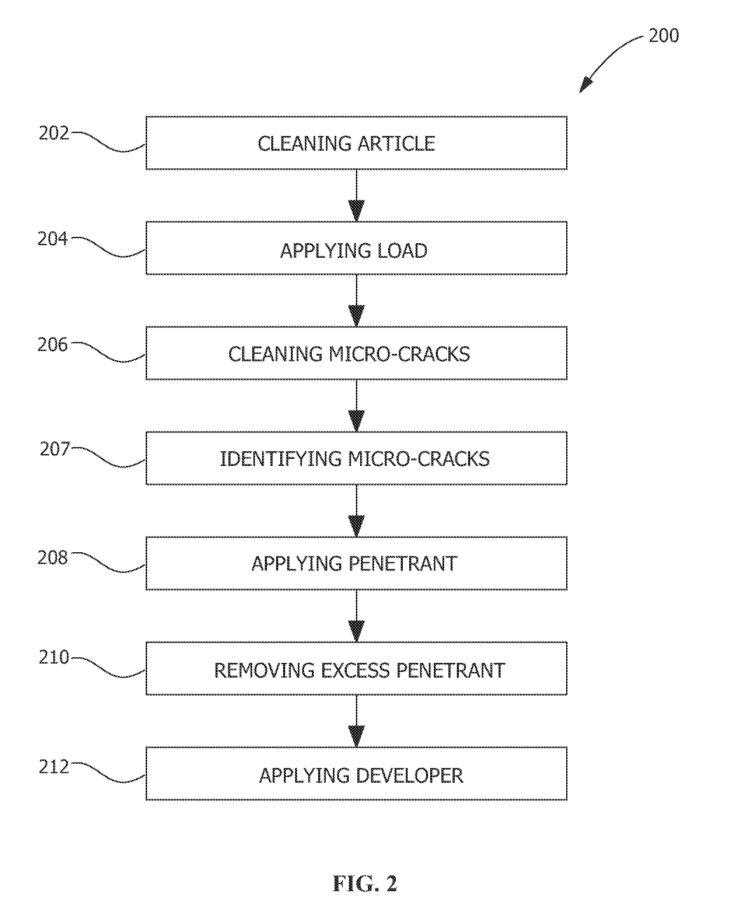

Referring to FIG. 2, an exemplary process 200 for detecting the visually indiscernible cracks 102 in the preselected portion 106 and/or the surface 108 of the article 100 includes multiple steps permitting the load to be applied and the visually indiscernible cracks 102 to be detectable. For example, in one embodiment, the process 200 includes applying the load to the article 100 (step 204) and applying a penetrant to the article 100 (step 208). As shown in FIG. 2, in a further embodiment, the process 200 includes one or more additional steps, such as, cleaning the article 100 (step 202), cleaning the visually indiscernible cracks 102 (step 206), identifying the visually indiscernible cracks 102 (step 207), removing the penetrant (step 210), and applying a developer to the article 100 (step 212).

In one embodiment, the article 100 is cleaned (step 202) before the applying of the load step (step 204). In a further embodiment, the cleaning is performed by spray-applying a cleaner to the surface 108 directly or to a wiping cloth, wiping the surface 108 with the wiping cloth, and allowing the surface 108 to dry. In one embodiment, the cleaner is a petroleum naphtha.

Applying the load 101 to the article 100 (step 204) is performed by the load-providing device 104. The load is provided by one or more application(s), for example, by a mechanical application (such as, an application that applies force by clamping, cranking, squeezing, wrenching, twisting, ratcheting, or combinations thereof), a hydraulic application (such as, an application that applies a force by pressure differentials, fluid motion, fluid insertion and/or removal, or combinations thereof), a computer-assisted application (such as, an application capable of applying an equation or algorithm for monitoring and/or adjusting an amount of force applied, an amount of movement and/or bending of the article 100 occurring, an amount of movement of a mechanical or hydraulic component, or combinations thereof), an automatic application (such as, an application that involves little or no input from a human, a self-contained process, an application that does not involve an individual providing the force for a mechanical application, an application that does not involve an individual making adjustments for a hydraulic application, or combinations thereof), a manual application (such as, an application that involves an individual providing the force for a mechanical application, an application that involves an individual making adjustments for a hydraulic application, or combinations thereof), other suitable applications, or combinations thereof.

The load direction 101 is any suitable direction. Suitable directions include, but are not limited to, a direction that will bend the preselected portion 106 and/or the surface 108, a direction that opens or expands the visually indiscernible cracks 102 in the preselected portion 106 and/or the surface 108, a direction that reveals visually indiscernible cracks 102 within the preselected portion 106 and/or the surface 108, a direction resulting in deflection of the preselected portion 106 and/or the surface 108, a direction corresponding to the orientation of the preselected portion 106 and/or the surface 108, or combinations thereof. In one embodiment, to apply the load in one or more of these directions, a plurality of vectors is identified (for example, two or three vectors). The force provided in the direction of each individual vector is applied by one load-providing device 104 capable of providing the force in the predetermined direction or by a plurality of load-providing devices 104 capable of providing the force in each of the individual vectors. In one embodiment, such as the computer-assisted application, the amount of force in each of the individual vectors corresponds with data monitored during the process and the amount of force of one or more of the individual vectors is adjusted based upon the data. In one embodiment, sufficient load is applied to translate into a predetermined amount of deflection of the article 100. In one embodiment, the force applied is about ⅓ the yield point stress for the article 100 and/or an amount that will not result in permanent deformation of the article 100 due to the addition of the load. In one embodiment, the force applied is greater than about ⅓ the yield point stress for the article 100 and/or an amount that will result in permanent deformation of the article 100 due to the addition of the load. In one embodiment, the force applied is less than about ⅓ the yield point stress for the article 100 and/or an amount that will not result in permanent deformation of the article 100 due to the addition of the load.

In one embodiment, for example, with the article 100 being a turbine bucket, the load is applied to a portion of the article 100, such as adjacent bucket fingers 110. In this embodiment, a distance between the bucket fingers 110 is measured by use of a measuring device 112 (such as a ruler or caliper). The measurement is recorded. The load-providing device 104 applies the load to one or more of the bucket fingers 110. In the embodiment shown in FIG. 1, the load is applied by mechanical application of force from the turning of a threaded portion 114 of a clamp 116. The resulting movement of the bucket fingers 110 is recorded. In one embodiment, the resulting movement is compared to a predetermined distance or range, for example, between about 13 and about 16 mils, between about 14 and about 15 mils, at about 14 mils, at about 14.5 mils, at about 15 mils, or combinations and sub-combinations thereof. In one embodiment, the resulting movement correlates to the size and geometry of the article, permitting the application of the load to render the visually indiscernible cracks 102 identifiable.

The load is applied with any suitable conditions. For example, the load is applied under ambient conditions, with externally supplied heating, with externally supplied cooling, with externally supplied heating then cooling, with externally supplied cooling then heating, any other suitable conditions, by applying a temperature gradient (for example, by transferring heat from an inspection region to generate localized tensile stress causing a localized compressive stress on another portion of the article 100), or combinations thereof.

Referring to FIG. 2, in one embodiment, the article 100 is cleaned (step 206) after the applying of the load step (step 204). In a further embodiment, the cleaning is performed by spray-applying a cleaner to the surface 108 directly or to a wiping cloth, wiping the surface 108 with the wiping cloth, and allowing the surface 108 to dry. In one embodiment, the cleaner is a petroleum naphtha.

In one embodiment, the visually indiscernible cracks 102 are identified (step 207). In one embodiment, the identifying is a non-destructive technique, such as visual analysis. In this embodiment, the technique is easier to perform and/or more reliable than use of the technique without application of the load. In another embodiment, the detecting is a non-destructive technique, such as Other detection processes can include using non-destructive inspection technology, such as, eddy current testing, magnetic particle testing, radiography, and/or any other non-destructive test impacted by changes in volumetric properties.

Application of the penetrant to the article 100 (step 208) is performed by any suitable technique, for example, by wiping or by using a cotton swab. In one embodiment, the penetrant is a water washable penetrant, for example, including surface-active agents, dibasic esters, and fluorescent dyes. In one embodiment, the penetrant is applied for a duration between about 20 and about 30 minutes and/or at a temperature between about 50° F. and about 125° F., ambient temperature of the article 100. Penetrant travels into the visually indiscernible cracks 102 and excess penetrant remains on the surface 108. By increasing the detection capability, the penetrant in the visually indiscernible cracks 102 permits treatment of the visually indiscernible cracks 102, resulting in increased properties for the article 100.

The excess penetrant is removed (step 210) by any suitable technique. In one embodiment, the load-providing device 104 is removed from the article 100, the excess penetrant is removed from the preselected portion 106 and/or the surface 108 of the article 100 (for example, with a water-moistened lint-free paper towel), a blacklight is applied to confirm removal of the excess penetrant, and additional iterations of removing the excess penetrant are performed as is appropriate.

The developer is applied to the article 100 (step 212) by any suitable technique. In one embodiment, the preselected portion 106 and/or the surface 108 are dried (for example, air dried), a light coating of the developer is applied to the preselected portion 106 and/or the surface 108, the developer remains on the preselected portion 106 and/or the surface 108 for a predetermined period of time (for example, about 5 to about 10 minutes), and the developer is removed. In one embodiment, the developer is reapplied permitting increased identification capability and/or confirmation. Upon removal of the developer, in one embodiment, the visually indiscernible cracks 102 are documented, for example, by measuring the length, direction, position, other suitable data, or combinations thereof.

In one embodiment, the developer is a suspension of developing particles in a fast-drying solvent, such as a blend including isopropanol and acetone, capable of being applied by spray (for example, aerosol or conventional spray gun). In another embodiment, the developer is a sodium alumino silicate. The developer further increases detectability thereby permitting treatment of the visually indiscernible cracks 102, resulting in increased properties for the article 100.

In one embodiment, upon the visually indiscernible cracks 102 being detected, the article 100 is treated by any suitable technique. In one embodiment, the visually indiscernible cracks 102 are treated by suitable techniques including, but not limited to, shot peening, blending, machining, grinding, polishing, and combinations thereof. In one embodiment, one or more of the characteristics of the visually indiscernible cracks 102 described above are treated corresponding to one or more of the article 100 features described above.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A detection process, comprising:
applying a load to a preselected portion of an article during a non-operational mode;
wherein the applying of the load permits visually indiscernible cracks in the preselected portion of the article to be detected.

2. The process of claim 1, further comprising identifying the visually indiscernible cracks.

3. The process of claim 2, wherein the identifying is a non-destructive method.

4. The process of claim 1, wherein the load is provided by a load-providing device.

5. The process of claim 4, wherein the load-providing device is selected from the group consisting of a clamp, a vice, a suspended weight, a wedge, and a lever.

6. The process of claim 1, wherein the load is mechanically applied.

7. The process of claim 1, wherein the load is hydraulically applied.

8. The process of claim 1, wherein the load is applied to a predetermined amount, the predetermined amount being an amount capable of bending the preselected portion of the article.

9. The process of claim 1, wherein the load is applied to a predetermined amount, the predetermined amount being an amount resulting in deflection of the preselected portion of the article.

10. The process of claim 1, further comprising applying a penetrant to the article.

11. The process of claim 1, further comprising applying a developer to the article.

12. The process of claim 1, wherein the article is a turbine bucket.

13. The process of claim 12, wherein the preselected portion is a bucket finger of the turbine bucket.

14. The process of claim 1, further comprising treating the visually indiscernible cracks.

15. The process of claim 14, wherein the treating is by shot peening.

16. The process of claim 14, wherein the article is metal or metallic.

17. The process of claim 14, wherein the visually indiscernible cracks are substantially devoid of damage within the grain boundaries of the preselected portion due to the treating of the visually indiscernible cracks.

18. The process of claim 14, wherein the visually indiscernible cracks are substantially devoid of damage of compressive stress in the preselected portion due to the treating of the visually indiscernible cracks.

19. A detection process, comprising:
applying a load to a preselected portion of an article, wherein the applying of the load permits visually indiscernible cracks in the preselected portion of the article to be detected;
treating the visually indiscernible cracks.

20. A detection process, comprising:
applying a load to a preselected portion of an article to reveal visually indiscernible cracks; and
identifying the visually indiscernible cracks.
